(19) United States
(12) Patent Application Publication
(10) Pub. No.: US 2003/0152015 A1
(43) Pub. Date: Aug. 14, 2003

(54) Photoreceiver amplifier circuit and optical pickup employing the same

(75) Inventor: Katsuyuki Kawamura, Kitakatsuragi-gun (JP)

Correspondence Address: Barry E. Bretschneider, Morrison & Foerster LLP, 1650 Tysons Boulevard, Suite 300, McLean, VA, 22102, US

(73) Assignee: Sharp Kabushiki Kaisha, Osaka (JP)

(21) Appl. No.: 10/358,143

(22) Filed: Feb. 5, 2003

(30) Foreign Application Priority Data
Feb. 12, 2002 (JP) 2002-033438

(51) Int. Cl. G11B 7/005

(52) U.S. Cl. 369/124.11

(57) ABSTRACT

A photoreceiver amplifier circuit has an amplifier for amplifying the detection signal of a photoreceiver device, a plurality of negative feedback circuits connected between the input terminal and the output terminal of the amplifier in parallel with one another so as to form different negative feedback loops, and a switch circuit for selecting one among the plurality of negative feedback circuits. The frequency band and/or the gain of the photoreceiver amplifier circuit is varied according to the detection signal of the photoreceiver device. This makes it possible to switch the frequency band without degradation in amplification characteristics.

### BACKGROUND OF THE INVENTION

1. Field of the Invention

The present invention relates to a photoreceiver amplifier circuit for amplifying the detection voltage of a photoreceiver device, and to an optical pickup employing such a photoreceiver amplifier circuit.

2. Description of the Prior Art

In recent years, in optical disk apparatuses as represented by CD-R drive apparatuses and DVD-R drive apparatuses, to permit optical disks to be rotated at higher and higher rates when data is read therefrom, and to make it possible to write data to optical disks, there have been demands for photoreceiver amplifier circuits that can accurately amplify both a high-frequency signal used when data is read and a pulse signal used when data is written. Such a photoreceiver amplifier circuit can be realized by switching its frequency band according to the type of the input signal fed thereto.

FIG. 5 is a circuit diagram showing a conventional example of a photoreceiver amplifier circuit, showing in particular the circuit configuration of the front-end amplifier constituting the photoreceiver amplifier circuit. The front-end amplifier of the photoreceiver amplifier circuit shown in this figure includes npn-type transistors Q1 and Q2 that form a differential pair that receives the detection voltage of a photoreceiver device PD1 and a direct-current supply voltage E1 as a reference voltage, pnp-type transistors Q3 and Q4 that form an active load, an npn-type transistor Q5 that forms an output stage, constant-current sources I1 and I2, a phase compensation capacitor C1, and a switch circuit sw1.

The base of the transistor Q1, which serves as the inverting input terminal of the front-end amplifier, is connected to the cathode of the photoreceiver device PD1. The anode of the photoreceiver device PD1 is grounded. The base of the transistor Q2, which serves as the non-inverting input terminal of the front-end amplifier, is connected to the positive terminal of the direct-current supply voltage E1. The negative terminal of the direct-current supply voltage E1 is grounded. The emitters of the transistors Q1 and Q2 are connected together, and the node between them is grounded through the constant-current source I1.

The collector of the transistor Q1 is connected to the collector of the transistor Q3. The collector of the transistor Q2 is connected to the collector of the transistor Q4, to the base of the transistor Q5, and to one end of the phase compensation capacitor C1. The other end of the phase compensation capacitor C1 is grounded through the switch circuit sw1.

The bases of the transistors Q3 and Q4 are connected together, and the node between them is connected to the collector of the transistor Q3. The emitters of the transistors Q3 and Q4 are both connected to the supply voltage line. The emitter of the transistor Q5 is grounded through the constant-current source 12. The collector of the transistor Q5 is connected to the supply voltage line.

It is true that, with the photoreceiver amplifier circuit configured as described above, its frequency band can be switched by switching the phase compensation capacitor C1 provided in the front-end amplifier. Thus, it is possible to handle both a high-frequency signal used in data reading and a pulse signal used in data writing.

However, with the photoreceiver amplifier circuit configured as described above, when the switch circuit sw1 is open, the phase compensation capacitor C1 functions as a parasitic capacitance with respect to the amplifier stage. Thus, as the operation speed of the photoreceiver amplifier circuit is increased, the parasitic capacitance acts to degrade the amplification characteristics of the photoreceiver amplifier circuit. Moreover, compensation for a delay in phase performed in the front-end amplifier described above acts to narrow the frequency band of the photoreceiver amplifier circuit, and thus makes the photoreceiver amplifier circuit unsuitable to be adapted for higher operation speeds. Furthermore, in recent years, there have been demands also for photoreceiver amplifier circuits that can accurately amplify reproduced signals obtained from optical disks with different reflectivities. This cannot be achieved with the photoreceiver amplifier circuit configured as described above.

### SUMMARY OF THE INVENTION

An object of the present invention is to provide a photoreceiver amplifier circuit that can switch its frequency band without degradation in its amplification characteristics, and to provide an optical pickup employing such a photoreceiver amplifier circuit.

To achieve the above object, according to the present invention, a photoreceiver amplifier circuit is provided with: an amplifier for amplifying the detection signal of a photoreceiver device; a plurality of negative feedback circuits connected between the input terminal and the output terminal of the amplifier in parallel with one another so as to form different negative feedback loops; and a switch circuit for selecting one among the plurality of negative feedback circuits. Here, the frequency band and/or the gain of the photoreceiver amplifier circuit is varied according to the detection signal of the photoreceiver device.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a block diagram of an optical disk apparatus embodying the invention;

FIG. 2 is a circuit diagram of the photoreceiver amplifier circuit of a first embodiment of the invention;

FIG. 3 is a circuit diagram of an example of the circuit configuration of the negative feedback circuit F1;

FIG. 4 is a circuit diagram of the photoreceiver amplifier circuit of a second embodiment of the invention; and

FIG. 5 is a circuit diagram of a conventional example of a photoreceiver amplifier circuit.

### DESCRIPTION OF THE PREFERRED EMBODIMENTS

Hereinafter, photoreceiver amplifier circuits embodying the present invention will be described, taking up examples in which they are applied to the optical pickup of an optical disk apparatus (for example, a DVD-R drive apparatus) that permits writing and reading of data to an from an optical disk.

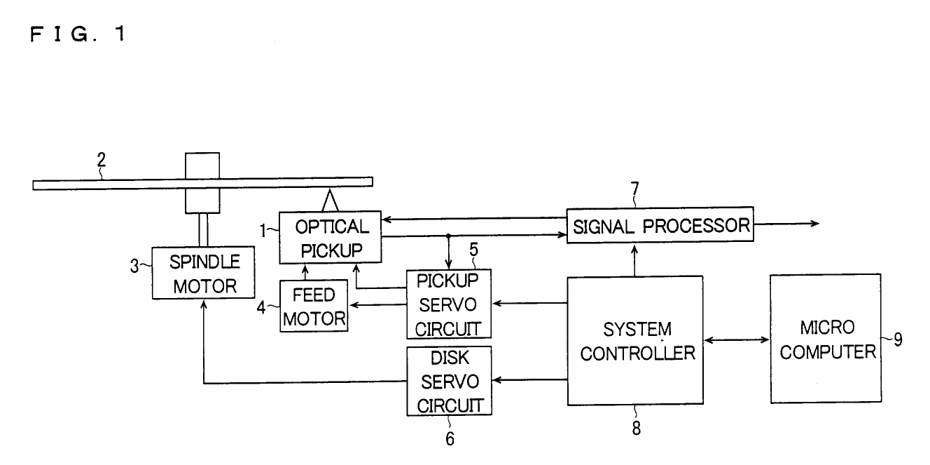

FIG. 1 is a diagram showing an outline of the configuration of an optical disk apparatus embodying the invention. In the optical disk apparatus shown in this figure, when data is written to or read from an optical disk 2, an optical pickup 1 is slid in the direction of a radius of the optical disk 2 by a feed motor 4, and the optical disk 2 is rotated with constant linear velocity by a spindle motor 3. This makes the optical pickup 1 scan along a recording track on the optical disk 2.

According to instructions from a microcomputer 9, a system controller 8 controls the entire system of the optical disk apparatus by feeding appropriate control signals to a pickup servo circuit 5, a disk servo circuit 6, and a signal processor 7.

According to the control signal fed from the system controller 8 and a focus error signal and a tracking error signal detected by the optical pickup 1, the pickup servo circuit 5 controls the focus servo and tracking servo of the optical pickup 1 and the amount of slide movement of the optical pickup 1.

According to the control signal fed from the system controller 8 and a reproduction clock (not shown) fed from the signal processor 7, the disk servo circuit 6 produces a rotation servo signal for rotating the optical disk 2 with constant linear velocity, and feeds the rotation servo signal to the spindle motor 3.

When data is read, the signal processor 7, according to the control signal fed from the system controller 8, performs error correction, decoding, and other operations on a reproduced information signal detected by the optical pickup 1, and feeds the so processed reproduced information signal to the circuit provided in the next stage (not shown). On the other hand, when data is written, the signal processor 7, according to the control signal fed from the system controller 8, performs encoding, error correction, and other operations on a to-be-recorded information signal to be recorded on the optical disk 2, and feeds the so processed to-be-recorded information signal to the optical pickup 1.

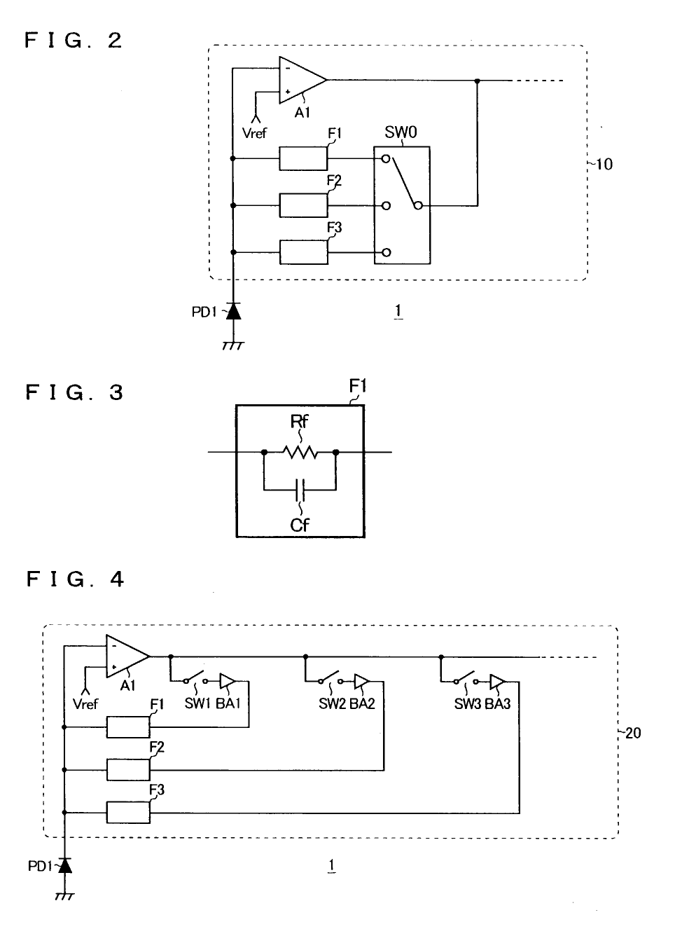

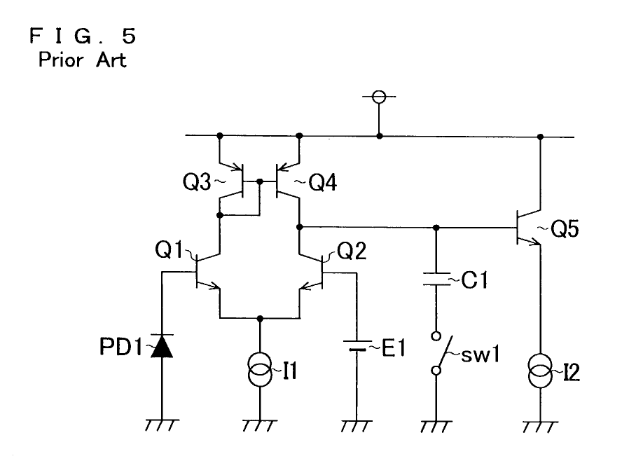

Next, the photoreceiver amplifier circuit of a first embodiment of the invention employed in the optical pickup 1 will be described in detail. FIG. 2 is a diagram showing an outline of the configuration of the photoreceiver amplifier circuit of the first embodiment. The photoreceiver amplifier circuit 10 employed in the optical pickup 1 is an amplifier circuit that amplifies the signal (input signal) detected by a photodiode PD1 used as a photoreceiver device in the optical pickup 1 and that then feeds the amplified signal to the signal processor 7 (not shown) provided in the next stage. The photoreceiver amplifier circuit 10 has, as its first-stage amplifier, a front-end amplifier A1.

The front-end amplifier A1 receives at its non-inverting input terminal (+) a predetermined reference voltage Vref, and has its inverting input terminal (−) connected to the cathode of the photodiode PD1. The anode of the photodiode PD1 is grounded. Thus, the output voltage output from the front-end amplifier A1 is a voltage obtained by amplifying the differential voltage between the input voltage obtained from the photodiode PD1 and the reference voltage Vref.

The output terminal of the front-end amplifier A1 is connected to the signal processor 7 (not shown) provided in the next stage, and also to the common terminal of a switch circuit SW0 that has a plurality of selection terminals (in this embodiment, three terminals). The selection terminals of the switch circuit SW0 are each connected through a corresponding negative feedback circuit (in this embodiment, one of three negative feedback circuits F1, F2, and F3) to the inverting input terminal (−) of the front-end amplifier A1 so as to form a plurality of negative feedback loops that are different from one another.

FIG. 3 is a circuit diagram showing an example of the configuration of the negative feedback circuit F1. As shown in this figure, in this embodiment, the negative feedback circuit F1 is composed of a gain resistor Rf1 and a phase compensation capacitor Cf1 connected in parallel. Though not illustrated, the negative feedback circuits F2 and F3 are configured likewise. Specifically, the negative feedback circuit F2 is composed of a gain resistor Rf2 and a phase compensation capacitor Cf2 connected in parallel, and the negative feedback circuit F3 is composed of a gain resistor Rf3 and a phase compensation capacitor Cf3 connected in parallel.

In a photoreceiver amplifier circuit including a negative feedback circuit composed of a gain resistor (having a resistance Rf) and a phase compensation capacitor (having a capacitance Cf) connected in parallel, the frequency band of the photoreceiver amplifier circuit is determined by its cut-off frequency fc, which is given by

$$f c = \frac{1}{2 π \cdot R f \cdot C f} \qquad ( 1 )$$

Equation (1) above shows that the frequency band and the gain of the photoreceiver amplifier circuit can be varied by appropriately adjusting the resistance Rf of the gain resistor and the capacitance Cf of the phase compensation capacitor.

On this principle, in the photoreceiver amplifier circuit 10 of this embodiment, the gain resistors Rf1 to Rf3 and the phase compensation capacitors Cf1 to Cf3 constituting the negative feedback circuits F1 to F3, respectively, are given different resistances and different capacitances from one another, and, according to the input signal from the photodiode PD1, the switch circuit SW0 switches among the negative feedback circuits F1 to F3 appropriately.

With this configuration, as opposed to conventional configurations, it is possible to switch the frequency band and the gain of the photoreceiver amplifier circuit 10 to optimum settings according to the input signal without degrading its amplification characteristics.

In the photoreceiver amplifier circuit 10 of this embodiment, the switch circuit SW0 is so controlled as to select the negative feedback circuit F1 when data is read, the negative feedback circuit F2 when data is written, and the negative feedback circuit F3 when data is read from an optical disk with a different reflectivity.

In a case where the frequency band of the photoreceiver amplifier circuit 10 is varied between when data is read and when data is written, the negative feedback circuits F1 and F2 are given different cutoff frequencies.

However, the resistances of the gain resistors Rf1 and Rf2 provided in the negative feedback circuits F1 an F2 are determined in advance on the basis of the amount of light incident on the photodiode PD1 (that is, the input voltage to the photoreceiver amplifier circuit 10) and the desired output voltage that is expected to be obtained from the photoreceiver amplifier circuit 10, and therefore cannot be varied greatly. Accordingly, to give the negative feedback circuits F1 and F2 different cutoff frequencies, it is necessary to give their phase compensation capacitors Cf1 and Cf2 different capacitances.

In the photoreceiver amplifier circuit 10 of this embodiment, the phase compensation capacitor Cf2 provided in the negative feedback circuit F2 is given a capacitance far greater than (about 100 times as high as) the capacitance of the phase compensation capacitor Cf1 provided in the negative feedback circuit F1. This makes it possible to realize a photoreceiver amplifier circuit that can accurately amplify both the high-frequency signal used in data reading and the pulse signal used in data writing.

On the other hand, to cope with data reading from optical disks with different reflectivities, the gain resistor Rf3 of the negative feedback circuit F3 is given a resistance different from the resistances of the gain resistors Rf1 and Rf2 of the negative feedback circuits F1 and F2. This makes it possible to realize a photoreceiver amplifier circuit that can accurately amplify reproduced signals obtained from optical disks with different reflectivities.

Next, the photoreceiver amplifier circuit of a second embodiment of the invention employed in the optical pickup 1 will be described. FIG. 4 is a diagram showing an outline of the configuration of the photoreceiver amplifier circuit of the second embodiment. The photoreceiver amplifier circuit 20 of this embodiment is devised to overcome the problem (while the parasitic capacitance within the front-end amplifier A1 is reduced, the negative feedback loop portion consisting of the negative feedback circuits F1 to F3 is accompanied by the parasitic capacitance of the switch circuit SW0) present in the photoreceiver amplifier circuit 10 of the first embodiment described above, and is characterized by the configuration around the switch circuit. Therefore, such circuit elements as are found also in the first embodiment will be referred to with the same reference numerals and symbols as in FIG. 2, and their explanations will not be repeated. In the following description, explanations will be given with emphasis placed on the configuration around the switch circuit, which characterizes this embodiment.

As shown in FIG. 4, in the photoreceiver amplifier circuit 20 of this embodiment, in place of the switch circuit SW0 described, earlier, there are provided a plurality of unsaturable switch circuits (in this embodiment, three switch circuits SW1, SW2, and SW3). The output terminal of the front-end amplifier A1 is connected to the signal processor 7 (not shown) provided in the next stage, and also to one end of each of the switch circuits SW1 to SW3. The other ends of the switch circuits SW1 to SW3 are each connected through a corresponding buffer BA1, BA2, or BA3 and a corresponding negative feedback circuit F1, F2, or F3 to the inverting input terminal (−) of the front-end amplifier A1 so as to form a plurality of negative feedback loops that are different from one another.

With this configuration, it is possible to reduce the parasitic capacitance within the front-end amplifier A1 without the negative feedback loop portion consisting of the negative feedback circuits F1 to F3 being accompanied by the parasitic capacitance of the switch circuits.

The first and second embodiments described above deal with cases where a switch circuit or switch circuits switch among three different negative feedback loops. However, the present invention may be practiced in any other configuration than specifically described above. For example, the number of negative feedback loops switched by the switch circuit(s) may be increased or decreased as required.

The photoreceiver amplifier circuit of the invention is so configured that part of the output is fed back, through a negative feedback circuit and thus with opposite phase, to the inverting input terminal of the front-end amplifier. As a result, the negative feedback circuit, thanks to its intrinsic function, enhances the frequency response and the S/N ratio of the photoreceiver amplifier circuit. It is also possible to maintain the gain stably against variations in temperature and in the supply voltage.

As described above, according to the invention, a photoreceiver amplifier circuit is provided with an amplifier for amplifying the detection signal of a photoreceiver device, a plurality of negative feedback circuits connected between the input terminal and the output terminal of the amplifier in parallel with one another so as to form different negative feedback loops, and a switch circuit for selecting one among the plurality of negative feedback circuits. Here, the switch circuit is so controlled that the frequency band and/or the gain of the photoreceiver amplifier circuit is varied according to the detection signal of the photoreceiver device. With this configuration, as opposed to conventional configurations, it is possible to switch the frequency band and the gain of the photoreceiver amplifier circuit to optimum settings according to the input signal without degrading its amplification characteristics.

In the photoreceiver amplifier circuit configured as described above, it is advisable that switching among the negative feedback circuits be achieved through the operation of a plurality of unsaturable switch circuits provided one for each of the negative feedback circuits. With this configuration, it is possible to reduce the parasitic capacitance within the amplifier without the negative feedback loop portion consisting of the negative feedback circuits being accompanied by the parasitic capacitance of the switch circuits.

According to the present invention, an optical pickup is provided with a photoreceiver amplifier circuit configured as described above so as to permit writing of data to and reading of data from an optical disk. With this configuration, it is possible to realize an optical pickup that can accurately amplify various signals fed thereto when data is read or written.

In the optical pickup configured as described above, it is advisable that there be provided as the negative feedback circuits, a first negative feedback circuit for heightening the frequency band of the amplifier and a second negative feedback circuit for lowering the frequency band of the amplifier so that the first negative feedback circuit is selected when data is read from the optical disk and the second negative feedback circuit is selected when data is written to the optical disk. With this configuration, it is possible to realize a photoreceiver amplifier circuit that can accurately amplify both a high-frequency signal used in data reading and a pulse signal used in data writing

In the optical pickup configured as described above, it is advisable that there be further provided, as the negative feedback circuits, a third negative feedback circuit for increasing the gain of the amplifier so that the third negative feedback circuit is selected when data is read from a low-reflectivity optical disk. With this configuration, it is possible to realize a photoreceiver amplifier circuit that can accurately amplify reproduced signals obtained from optical disks with different reflectivities.

What is claimed is:

1. A photoreceiver amplifier circuit comprising:
an amplifier for amplifying a detection signal of a photoreceiver device;
a plurality of negative feedback circuits connected between an input terminal and an output terminal of the amplifier in parallel with one another so as to form different negative feedback loops; and
a switch circuit for selecting one among the plurality of negative feedback circuits,
wherein a frequency band and/or a gain of the photoreceiver amplifier circuit is varied according to the detection signal of the photoreceiver device.

2. A photoreceiver amplifier circuit as claimed in claim 1,
wherein selection among the plurality of negative feedback circuits is achieved through operation of a plurality of unsaturable switches provided one for each of the negative feedback circuits.

3. A photoreceiver amplifier circuit as claimed in claim 1,
wherein the plurality of negative feedback circuits is each composed of a gain resistor and a phase compensation capacitor connected in parallel with each other.

4. An optical pickup comprising:
a photoreceiver amplifier circuit including an amplifier for amplifying a detection signal of a photoreceiver device, a plurality of negative feedback circuits connected between an input terminal and an output terminal of the amplifier in parallel with one another so as to form different negative feedback loops, and a switch circuit for selecting one among the plurality of negative feedback circuits, a frequency band and/or a gain of the photoreceiver amplifier circuit being varied according to the detection signal of the photoreceiver device,
wherein the optical pickup is for reading data from and writing data to an optical disk.

5. An optical pickup as claimed in claim 4,
wherein selection among the plurality of negative feedback circuits is achieved through operation of a plurality of unsaturable switches provided one for each of the negative feedback circuits.

6. An optical pickup as claimed in claim 4,
wherein the photoreceiver amplifier circuit includes, as the plurality of negative feedback circuits:
a first negative feedback circuit for heightening the frequency band of the amplifier; and
a second negative feedback circuit for lowering the frequency band of the amplifier,
the first negative feedback circuit being selected when data is read from the optical disk and the second negative feedback circuit being selected when data is written to the optical disk.

7. An optical pickup as claimed in claim 6,
wherein the first and second negative feedback circuits are each composed of a gain resistor and a phase compensation capacitor connected in parallel with each other, and a capacitance of the phase compensation capacitor included in the second negative feedback circuit is about 100 times as high as a capacitance of the phase compensation capacitor included in the first negative feedback circuit.

8. An optical pickup as claimed in claim 6,
wherein the photoreceiver amplifier circuit further includes, as the plurality of negative feedback circuits:
a third negative feedback circuit for increasing a gain of the amplifier,
the third negative feedback circuit being selected when data is read from a low-reflectivity optical disk.

9. An optical pickup as claimed in claim 8,
wherein the first, second, and third negative feedback circuits are each composed of a gain resistor and a phase compensation capacitor connected in parallel with each other, and a resistance of the gain resistor included in the third negative feedback circuit is higher than resistances of the gain resistors included in the first and second negative feedback circuits.
